(19) United States
(12) Patent Application Publication
(10) Pub. No.: US 2009/0035707 A1
(43) Pub. Date: Feb. 5, 2009

(54) RHEOLOGY-CONTROLLED CONDUCTIVE MATERIALS, METHODS OF PRODUCTION AND USES THEREOF

(76) Inventors: Yubing Wang, Piscataway, NJ (US); James Guiheen, Madison, NJ (US); Yuan-Ping Ting, Plainsboro, NJ (US); Gary L. Martin, Piscataway, NJ (US)

Correspondence Address: BUCHALTER NEMER, 18400 VON KARMAN AVE., SUITE 800, IRVINE, CA, 92612, US

(21) Appl. No.: 11/832,067

(22) Filed: Aug. 1, 2007

(51) Int. Cl. H01B 1/00; G03C 5/00

(52) U.S. Cl. 430/322; 252/500; 252/502; 252/506; 252/514

(57) ABSTRACT

Compositions comprising at least one conductive nanomaterial and at least one rheology control additive are disclosed. These compositions can be used to form a film for uses requiring sufficient conductivity and light transparency. Methods of forming a conductive composition include: providing at least one conductive nanomaterial, providing at least one rheology control additive, and blending the at least one conductive nanomaterial and the at least one rheology control additive together to form the conductive composition. Methods of forming patterned transparent conductive coatings include: providing and applying a layer comprising at least one photosensitive or photoimageable composition to a surface, providing and applying a layer comprising at least one conductive nanomaterial and at least one rheology control additive, exposing and developing the layered material, and treating the layer comprising the at least one rheology control additive in order to remove at least part of the rheology control additive. Coating compositions, films, patterned films and structures containing these films and patterned films are also described.

### FIELD OF THE SUBJECT MATTER

Rheology-controlled conductive materials, compounds and compositions, their methods of production and uses in various applications are described herein, including the production and use of conductive materials in combination with rheology control additives.

### BACKGROUND

In the production of certain applications in the microelectronics and optoelectronics industries, it is necessary and/or useful to have a substantially transparent conductive material or layer. Transparent conductive materials are known in the art, and these transparent conductive materials and layers are often utilized to provide electrical connectivity between electrodes. Integrated circuits, interposers, flat panel displays, touchpanels, photovoltaics, transparent heaters, electrochemical devices, electro-optic devices, multichip modules, bumping redistribution, passivation stress buffers, and thin film build-up layers on printed circuit boards are examples of applications where having transparent conductive materials and layers, especially patterned ones, are useful and sometimes necessary.

Transparent conducting oxides (TCOs) are often used as transparent conductors, but have several drawbacks. Electrically conductive transparent films are well-known in the patent and scientific literature. In addition, there are several currently accepted methods of producing these films. (see MRS Bulletin, August 2000, Vol. 25 (8), ISSN: 0883-7694). Conventional methods of laying down these films on substrates, such as dielectrics, include either the dry or wet processing of metal oxides and mixed metal oxides. In dry processes, PVD (including sputtering, ion plating and vacuum deposition) or CVD is used to form a conductive transparent film of a metal oxide, such as tin-indium mixed oxide (ITO), antimony-tin mixed oxide (ATO) and fluorine-doped tin oxide (FTO), aluminum-doped zinc oxide (FZO). The films produced using dry processes have both good transparency and good conductivity. However, these films require complicated apparatus having a vacuum system and the use of such apparatus result in substandard productivity. Other problems with dry processes include insufficient application results when trying to apply these materials to continuous and/or large substrates. In conventional wet processes, as disclosed in U.S. Pat. No. 3,331,702, thermal dissociation of liquid precursors is used. In all of these conventional methods using metal oxides and mixed oxides, the materials suffer from supply restriction, lack of spectral uniformity and brittleness, and serious processing complexity, which result in a relatively high cost.

Other solvent-based materials and compositions can be used to produce transparent conductive materials. In order to address the shortcomings of conventional dry and wet methods of preparing transparent conducting oxides, more recent literature has described the use solutions or dispersions of carbon nanotubes, electrically conductive powders mixed with binders, inherently conductive polymers (ICPs), metal nanowires and/or combinations thereof. US Publication No.: 2006/0274047 and http://www.fujitsu.com/global/news/pr/archives/month/2003/20031222-02.html) discuss the use of ICPs in transparent conductors. Also, U.S. Pat. No. 6,416,818 and Japanese Patent Application No.: JP-10258486 discloses the use of semiconducting powder (ITO particulate)-containing resins for use as transparent conductors. ITO-particulates are also disclosed in “Indium Tin Oxide (ITO) Thin Film Fabricated by Indium-Tin-Organic sol with ITO Nanoparticle at Low Temperature”, IMID/IDMC '06 Digest, by S. J. Hong et al and are marketed by companies such as Milliken Corp., DeGussa Corp. and AirProducts for use in dispersion-based transparent conductive coating. The use of metal nanowires as transparent conductors is disclosed in US Patent Application 2007/0074316.

Both multiwalled (MWCNT) and single-walled carbon nanotubes (SWCNT) can be used to prepare transparent conductors. U.S. Pat. No. 5,853,877 discloses the use of multiwalled carbon nanotubes to produce transparent conductors, and U.S. Pat. No. 7,060,241 discloses the use of single walled carbon nanotubes to produce transparent conductors.

For dispersions of electrically conductive nanomaterials (such as SWCNTs, MWCNTs, metal nanowires, or semiconductor nanomaterials) which are used to produce an electrically conductive material, it is desirable to prepare a dispersion in which the conductive nanomaterial is well dispersed without introducing ingredients that might lower conductivity of conductive material. Due to their relatively high surface areas, these nanomaterials often present difficulties in processing into dispersions.

Carbon nanotubes (CNTs) are often difficult to process in the “as-manufactured state” because of the lack of surface chemical groups that are compatible with common solvents, additives and various polymer matrices. It is therefore often desirable to “functionalize” the surface of the CNTs to improve the solvent compatibility by adding surface chemical species to the CNTs. There are several chemical procedures already known in the art, which are known to facilitate functionalization of the CNTs, however, there are also a number of drawbacks to these procedures.

One conventional technique for dispersing nanotubes in a solvent, such as water, is the introduction of surfactants (or polymers), which non-covalently modifies the surface chemistry of the CNTs. An article in the Journal of Physical Chemistry (J. Phys Chem B 205, 109) pp 14454-14460, by Y. Tan and D. E. Resasco), and Japanese Patent 05014387 discloses the use of such surfactants. However, surfactants greatly reduce the electrical conductivity of the CNTs and are often counterproductive in preparing nanomaterial dispersions for transparent conductors. The surfactant also causes problems for further coating formulations, including utilizing resources, time and effort in trying to remove the surfactant. When surfactants are used, the surfactants remain on the nanomaterials after the solvent is removed to form the film, and act to insulate the nanoparticles from one another and so act to reduce the conductivity performance of the transparent conductor. Therefore, when preparing a dispersion for use as in a transparent conductor, even though one skilled in the art would ordinarily envision using a surfactant-based dispersion to improve performance, use of the dispersant tends to decrease performance.

Another conventional method of dispersing nanotubes is to selectively provide covalently-bonded surface chemical groups to the CNTs in such a manner that solvent compatibility is achieved, while maintaining some level of electrical conductivity U.S. Pat. No. 5,853,877 conjectures that treatment of MWCNTs in strong acids causes carboxyl or nitro groups to form on the surface of the MWCNT, and the formation of those groups improves dispersion. An article in the International Journal of Nanoscience (Volume 4, No 1, 2005, pp 119-137, by N. Nakashima) provides a good review of how surface functionalization is achieved for MWCNTs and SWCNTs. Even though these functionalization methods have benefit in forming dispersions, it is generally known that functionalized tubes have lower electrical conductivity than un-functionalized CNTs because the walled of the CNTs are chemically modified from their pristine state and the electronic density of state is less ordered.

Even though transparent conductors have been made from dispersions of functionalized and un-functionalized CNTs, and have been made from nanowires, and from nanoparticles, there are no significant detailed descriptions of such dispersion of nanoparticles wherein a rheology control additive has been added to the dispersion to allow the dispersion to be useful in commercial coating processes such as gravure coating, slot die coating, spray coating, spin-on coating and the like. When a nanomaterial containing composition is used to form a coating or printing ink, the viscosity of a nanomaterial composition needs to be sufficiently high to allow the coating to properly fill the coating tool, and to maintain the coating position.

Therefore, there continues to be a need in the art for nanomaterial compositions, transparent conductive materials and films made therefrom that exhibit one or more of the following characteristics are easily and efficiently produced, can be produced prior to application or in situ, are easily applied to surfaces and substrates, can be produced and used with materials and methods that are generally accepted by the flat panel display (FPD) industry, along with other industries that produce and utilize microelectronics, can be tailored to be photoimageable and patternable using accepted photolithography techniques, have superior optical properties and have superior film forming properties, including good adhesion to other adjacent layers, the ability to be laid down in very or ultra thin layers and the ability to remain substantially transparent when laid down as thicker layers.

### SUMMARY OF THE SUBJECT MATTER

Compositions comprising at least one conductive nanomaterial and at least one rheology control additive are disclosed. These compositions can be used to form a film for uses requiring sufficient conductivity and light transparency.

Methods of forming a conductive composition include: providing at least one conductive nanomaterial, providing at least one rheology control additive, and blending the at least one conductive nanomaterial and the at least one rheology control additive together to form the conductive composition. Methods of forming patterned transparent conductive coatings include: providing and applying a layer comprising at least one photosensitive or photoimageable composition to a surface, providing and applying a layer comprising at least one conductive nanomaterial and at least one rheology control additive, exposing and developing the layered material, and treating the layer comprising the at least one rheology control additive in order to remove at least part of the rheology control additive.

Coating compositions, films, patterned films and structures containing these films and patterned films are also described.

### DETAILED DESCRIPTION

In an effort to address the goals and desirable characteristics identified in the background, including the elimination of additional surfactants, compositions of conductive nanomaterials blended with at least one rheology-control additive, and transparent conductive materials and films that comprise this composition are disclosed herein. Conductive nanomaterials include functionalized and unfunctionalized carbon nanotubes, semiconductor nanowires, semiconductor nanoparticles, metal nanowires, or a combination thereof. Conductive nanomaterials, such as functionalized carbon nanotubes, semiconductor nanowires, semiconductor nanoparticles, metal nanowires, or a combination thereof, are blended with at least one rheology-control additive to form transparent conductive materials and films. These compositions also advantageously comprise commonly-used solvents in order to form coating compositions and electrically conductive films.

In some embodiments, these compositions comprise less than 5% surfactants. In other embodiments, contemplated compositions comprise less than 1% surfactants. In yet other embodiments, contemplated compositions comprise no measurable amount of surfactants.

In addition, transparent conductive materials, articles and layers disclosed herein comprise a plurality of electrically conductive nanomaterials, such as functionalized or unfunctionalized carbon nanotubes, semiconductor nanowires, semiconductor nanoparticles, metal nanowires, or a combination thereof, at least one rheology-control additive, and in some embodiments, at least one additional conductive component, at least one photoimageable or photosensitive material or a combination thereof. These conductive materials may also be utilized in other compositions, such as conductive 25 inks or pastes.

In order to fully understand the advantages of the compositions produced herein, it is important to review the components of the compositions and the methods of production thereof. As mentioned, some contemplated compositions disclosed herein comprise a plurality of acid-functionalized carbon nanotubes and at least one rheology-control additive.

### Conductive Components

Compositions contemplated herein comprise at least one conductive component or nanomaterial. In some embodiments, contemplated compositions comprise at least two conductive components or nanomaterials. Contemplated conductive components are those materials that are capable of conducting electrons, such as discrete conductive structures, conductive nanowires, conductive nanoparticles, including metal and metal oxide nanoparticles, conductive nanotubes, including those described herein, and conducting polymers and composites. These conductive components may comprise metal, metal oxide, polymers, alloys, composites, carbon or combinations thereof, as long as the component is conductive.

Other conductive components include multiwalled or singlewalled conductive nanotubes, such as those described herein and in the prior art. These nanotubes may comprise carbon, metal, metal oxide, conducting polymers or a combination thereof. Some contemplated conductive materials may comprise those produced by utilizing the disclosure in U.S. application Ser. No. 11/751,977, filed on May 22, 2007 entitled “Transparent Conductive Materials and Coatings, Methods of Production and Uses Thereof”, which is commonly-owned and incorporated herein in its entirety by reference.

Additionally, it is contemplated that the at least one conductive component and/or the at least one conductive nanomaterial described herein may be selected and included based on a particular diameter, shape, aspect ratio or combination thereof. For example, nanowires and/or nanotubes may be specifically chosen to have at least a bimodal distribution, such that larger or longer components represent the “conductivity highway” and the smaller or shorter components ensure “connectivity”. As used herein, the phrase “aspect ratio” designates that ratio which characterizes the average particle size divided by the average particle thickness. In some embodiments, conductive components contemplated herein have a high aspect ratio, such as at least 100:1. In other embodiments, the aspect ratio is at least 300:1. A 100:1 aspect ratio may be calculated—in one embodiment—by utilizing components that are 6 microns by 600 Angstroms (wherein one micron 10,000 Angstroms).

As mentioned, some contemplated compositions disclosed herein comprise a plurality of conductive nanomaterials, which may include acid-functionalized carbon nanotubes. In some embodiments, methods of forming acid-functionalized carbon nanotubes comprise: a) providing a plurality of carbon nanotubes, b) providing at least one acid, c) blending the plurality of carbon nanotubes with the at least one acid to form the acid-functionalized carbon nanotubes. In additional embodiments, blending the plurality of carbon nanotubes with the at least one acid to form the acid-functionalized carbon nanotubes includes heating and/or agitating the blended mixture for a period of time. The treated carbon nanotubes and acid mixture can then be filtered and washed, which results in acid-functionalized carbon nanotubes and acid waste product. The acid-functionalized carbon nanotubes may be dried and used in that form or suspended in solution.

In certain embodiments, a plurality of carbon nanotubes is provided, while at the same time, at least one acid is provided. The plurality of carbon nanotubes may comprise one or more types of nanotubes, including single-wall CNTs, multiwalled CNTs, fibrils, vapor-grown carbon fibers, fullerene carbon tubules, or a combination thereof. These nanotubes may be purchased in whole or in part from outside sources, may be produced in part or in whole in-house or a combination thereof. The at least one acid comprises any suitable acid, as long as it allows for the acid-functionalization of at least part of the plurality of carbon nanotubes. In other embodiments, the at least one acid comprises HNO₃, H₂SO₄ or a combination thereof.

In some embodiments, the blended mixture of the at least one acid with the plurality of the carbon nanotubes are heated and/or agitated for a period of time. In some embodiments, the blended mixture is heated at a temperature of at least 30° C. In other embodiments, the blended mixture is heated at a temperature of at least 50° C. In yet other embodiments, the blended mixture is heated at a temperature of at least 60° C. With respect to the agitation, it is contemplated that the blended mixture may be agitated by any suitable device or method. Some contemplated agitating devices or methods include stirring, sonicating, shaking, vibrating, centrifuging or a combination thereof. In some embodiments, the period of time is that amount of time necessary to produce at least some acid-functionalized carbon nanotubes. In other embodiments, that period of time is at least 5 minutes. In yet other embodiments, that period of time is at least 20 minutes, and in other embodiments, that period of time is at least 30 minutes.

Another example of a contemplated conductive component is a discrete conductive structure, such as a metal nanowire, which comprises one or a combination of transition metals, such as silver, nickel, tantalum or titanium. As used herein, the term “metal” means those elements that are in the d-block and f-block of the Periodic Chart of the Elements, along with those elements that have metal-like properties, such as silicon and germanium. As used herein, the phrase “d-block” means those elements that have electrons occupying the 3d, 4d, 5d, and 6d orbitals surrounding the nucleus of the element. As used herein, the phrase “f-block” means those elements that have electrons occupying the 4f and 5f orbitals surrounding the nucleus of the element, including the lanthanides and the actinides. Other conductive components are contemplated, such as semiconductor nanowires and semiconductor nanoparticles.

Metal nanowires can be prepared by a variety of known methods. For example silver nanowires can be prepared via the reduction of silver salts such as silver nitrate from solution in the presence of a polyol such as ethylene glycol. Several recently prepared manuscripts provide a review of suitable techniques to prepare metal nanowires by a variety of techniques, for example Nanostructured Materials: Processing Properties and Application, edited by C. Koch (copyright 2007, by William Andrew, Norwich N.Y.), and “Size controlled synthesis of Nanoparticles by D. D. Evanoff, Jr., et al (J. Phys Chem B, 2004, 108, pp 13948-56).

Regarding semiconductor nanowires, TCO particulate (equiaxed) dispersions have been widely researched with patent filings dating from the late 1990s [see U.S. Pat. No. 6,416,818 and JP-10258486]. The conductivity levels reported were above 1000 Ohms/sq. High aspect ratio TCO particulates dispersion may have prospects for achieving an improved transparent conductor, especially if the contact resistance between nanowires can be kept low. A variety of semiconductor nanowires have been shown to be capable of being produced by potentially economical means such as vapor liquid solid approaches (Seu Yi Li, et al., Nanotechnology 16 (4), p 451-457, APRIL 2005), by co-precipitation anneal processes (Yu, D., et al., Materials Letters, Vol 58(1), January 2004, pp 84-87), and by direct thermal evaporation (Y Q Chen, et al., Journal of Physics D: Appl. Phys., 37, 3319-22, issue 23, 7 Dec. 2004; Jinhua Zhan, et al., Small, Vol 1 issue 8-9, p 883-888, 6 Jul. 2005; and Seung Yong Bae, et al., Applied Phys Letters, 86, 033102, (2005) 17 Jan. 2005,). More recently Sn-doped In₂O₃ nanowires have been prepared by epitaxial growth, with optical transmittance of ˜85% and resistivities as low as 6.3 E-5 Ohm-cm. However in none of these demonstrations of semiconductor nanowire synthesis was there any demonstration of the ability to pattern or the ability to control semiconductor nanowires dispersion viscosity.

### Rheology Control Additives

Contemplated compositions comprise at least one rheology control additive. Rheology control additives, which are also referred to as thickeners, or viscosifiers, may be either natural, or synthetic products. A good review of rheology control additives can be found in a recent book by D. B. Braun, and M. R. Rosen (Rheology Modifiers Handbook—Practical Use and Application, 2000, William Andrew Publishing). Rheology control additives are a group of multi-functional agents which provide desirable effects such as viscosity control, increased ability to suspend insoluble ingredients, increased emulsion stability, improved anti-sag and vertical surface cling performance, for example, U.S. Pat. No. 5,576,162 describes the use of thickeners in the preparation of nanomaterial-containing electrically conductive layers, but there is no teaching or guidance as to what constitutes a thickener, how it might be used, or the advantages and disadvantages of their use.

For those compositions, materials, layers and films disclosed herein, contemplated rheology control additives are those compounds that are used to provide a change in the zero-shear viscosity of a dispersion from less than 10 cP (Note: 1 cP=1 centiPoise=1 milliPascal second) to greater than 20 cP, and which give Newtonian, psuedoplastic, or thixotropic shear behavior for the range of shear rates of from 0.01 sec-1 to about 100,000 sec-1. Contemplated additives include:
Acrylic Polymers
Cross-linked Acrylic Polymers
Alginates
Associative Thickeners
Carrageenan
Microcrystalline Cellulose
Carboxymethylcellulose Sodium
Hydroxyethylcellulose
Hydroxypropylcellulose
Hydroxypropylmethylcellulose
Methylcellulose
Guar & Guar Derivatives
Locust Bean Gum
Polyethylene
Polyethylene Oxide
Polyvinylpyrrolidone
Xanthan Gum
Other compounds that provide a change in the zero-shear viscosity of a dispersion with from less than 10 cP to greater than 20 cP, and which give Newtonian, psuedoplastic, or thixotropic shear behavior for the range of shear rates of from 0.01 sec-1 to about 100,000 sec-1.

Recently, a additional class of rheology control additives has been shown to be useful when used to adjust the viscosity of nanomaterial-containing dispersions, including CNT dispersions. US Patent Publication No.: 2005/0276924 discloses liquid formulations that provide some measure of viscosity or rheology control through the use of amine-acid adducts. This patent discloses using an evaporatively-removable amine-acid adduct, specifically an amine-CO2 adduct. Such amine-CO2 adducts are zwitterions known as carbamates. This reference unfortunately does not disclose how to best utilize such rheology control to address a number of important problems. The reference fails to teach or suggest that utilizing such chemistry with nanomaterial formulations would be beneficial or desirable in the fabrication of transparent conducting layers. Furthermore, the reference fails to teach or suggest that utilizing such chemistry might be useful for patterning such transparent conductors via photochemistry. In addition, the reference fails to teach or suggest that utilizing such chemistry in combination with acid-functionalized carbon nanotubes would be beneficial or desirable in creating a conductive composition.

In contemplated compositions, the plurality of electrically conductive nanomaterials, such as functionalized carbon nanotubes, semiconductor nanowires, semiconductor nanoparticles, metal nanowires, or a combination thereof are blended or otherwise combined with at least one rheology-control additive. Rheology-control additives contemplated herein are those additives which control the viscosity of the composition in conjunction with the plurality of electrically conductive nanomaterials, such as functionalized carbon nanotubes, semiconductor nanowires, semiconductor nanoparticles, metal nanowires, or a combination thereof, and which would still allow for the composition to yield useful levels of electrical conductivity in the resultant electrical component such as a coating, film, or electrical element. For films made of such compositions useful electrical sheet resistances are envisioned to be in the range from 1 Ohm/square to 1E12 Ohm/square. In some embodiments, contemplated films have a percent light transmittance of at least 50%. In other embodiments, contemplated films have a percent light transmittance of at least 70%. In yet other embodiments, contemplated films have a percent light transmittance of at least 90%.

In some embodiments, rheology-control additives comprise amine-acid adducts. Contemplated amine-acid adducts may comprise carbamate chemistry. Other suitable rheology control additives include amine-acid adducts made from the amines selected from primary and secondary amines, especially those that have a boiling point at about the temperature of that of the solvent or the continuous phase of a liquid mixture. Zwitterion amine-acid adducts can be formed with acidic material materials including CO₂ carbon disulfide (CS₂), hydrogen chloride (HCl), and low boiling temperature organic acids (e.g. acetic acid, formic acid, propionic acid to name a few).

Contemplated rheology control additives may be added in any suitable amount, depending on the other components in the compositions, materials, layers and films, and may also be added in amounts suitable for the end use. In some embodiments, rheology control additives are added in an amount of less than about 50% of the total liquid weight. In other embodiments, rheology control additives are added in the range of about 1% to about 50% of the total liquid weight. In yet other embodiments, rheology control additives are added in an amount of less than about 30% of the total liquid weight. In some embodiments, rheology control additives are added in an amount of less than about 20% of the total liquid weight. In other embodiments, rheology control additives are added in an amount of less than about 10% of the total liquid weight.

Rheology control additives and conductive nanomaterials may be combined with at least one solvent. These solvents not only help to produce viscous solutions containing the conductive components and conductive nanomaterials, but may also help to produce better adhered films to substrates and surfaces.

### Solvents

Contemplated solvents include any suitable pure or mixture of molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound. A solvent may be optionally included in the composition to lower its viscosity and promote uniform coating onto a substrate by art-standard methods.

Contemplated solvents are those which are easily removed within the context of the applications disclosed herein. In some embodiments, contemplated solvents have a boiling point of less than about 250° C. In other embodiments, contemplated solvents have a boiling point in the range from about 50° C. to about 250° C., in order to allow the solvent to evaporate from the applied film without damage to the metal nanowires, nanoparticles, CNT network or the substrate. In order to meet various safety and environmental requirements, the at least one solvent has a high flash point (generally greater than about 40° C.) and relatively low levels of toxicity.

Suitable solvents comprise water and/or any single or mixture of organic, organometallic, or inorganic molecules that are volatized at a desired temperature. In some contemplated embodiments, the solvent or solvent mixture (comprising at least two solvents) comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosene, isobutylbenzene, methylnaphthalene, ethyltoluene, ligroine.

In other contemplated embodiments, the solvent or solvent mixture may comprise those solvents that are not considered part of the above-described hydrocarbon solvent family of compounds, such as ketones (such as acetone, diethyl ketone, methyl ethyl ketone and the like), alcohols, esters, ethers, amides and amines. In yet other contemplated embodiments, the solvent or solvent mixture may comprise a combination of any of the solvents mentioned herein. Contemplated solvents may also comprise aprotic solvents, for example, cyclic ketones such as cyclopentanone, cyclohexanone, cycloheptanone, and cyclooctanone; cyclic amides such as N-alkylpyrrolidinone, wherein the alkyl has from about 1 to 4 carbon atoms; N-cyclohexylpyrrolidinone and mixtures thereof.

Other organic solvents may be used herein insofar as they are able to aid dissolution of an adhesion promoter (if used) and at the same time effectively control the viscosity of the resulting solution as a coating solution. Adhesion promoters can also be called primers or binders Adhesion promoters which may be useful in the electrically-conductive compositions of this invention include: water-soluble polymers such as gelatin, gelatin derivatives, maleic acid anhydride copolymers; cellulose compounds such as carboxymethyl cellulose, hydroxyethyl cellulose, cellulose acetate butyrate, diacetyl cellulose or triacetyl cellulose; synthetic hydrophilic polymers such as polyvinyl alcohol, poly-N-vinylpyrrolidone, acrylic acid copolymers, polyacrylamides, their derivatives and partially hydrolyzed products, vinyl polymers and copolymers such as polyvinyl acetate and polyacrylate acid esters; derivatives of the above polymers; and other synthetic resins. Other potentially suitable binders include aqueous emulsions of addition-type polymers and interpolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, olefins, and aqueous dispersions of polyurethanes or polyesterionomers. Other classes of film-forming binders that may be useful in this invention are the polyalkoxysilanes, the polyesteranionomers. It is contemplated that various methods such as stirring and/or heating may be used to aid in the dissolution. Other suitable solvents include dibutyl ether, cyclic dimethylpolysiloxanes, butyrolactone, γ-butyrolactone, 2-heptanone, ethyl 3-ethoxypropionate, 1-methyl-2-pyrrolidinone, propylene glycol methyl ether acetate (PGMEA), hydrocarbon solvents, such as mesitylene, xylenes, benzene, toluene di-n-butyl ether, anisole, acetone, 3-pentanone, 2-heptanone, ethyl acetate, n-propyl acetate, n-butyl acetate, ethyl lactate, ethanol, 2-propanol, dimethyl acetamide, propylene glycol methyl ether acetate, and/or combinations thereof.

At least one solvent may be present in compositions and coatings contemplated herein in any suitable amount. In some embodiments, the at least one solvent may be present in an amount of less than about 95% by weight of the overall composition. In other embodiments, the at least one solvent may be present in an amount less than about 75% by weight of the overall composition. In yet other embodiments, the at least one solvent may be present in an amount of less than about 60% by weight of the overall composition. In another contemplated embodiment, the at least one solvent may be present in an amount from about 10% to about 95% by weight of the overall composition. In yet another contemplated embodiment, the at least one solvent may be present in an amount from about 20% to about 75% by weight of the overall composition. In other contemplated embodiments, the at least one solvent may be present in an amount from about 20% to about 60% by weight of the overall composition. It should be understood that the greater the percentage of solvent utilized, the less viscous the resulting solvent nanoparticle dispersion.

In some embodiments, rheology-control additives, acid-functionalized carbon nanotubes or a combination thereof can be added to an isopropyl alcohol (IPA)-water mixture. This mixture can be agitated for a period of time. In addition, the mixture may be centrifuged, which results in a supernatant layer and a precipitate layer. The supernatant layer may comprise acid-functionalized carbon nanotubes suspended in the IPA-water mixture. The precipitate layer may merely comprise acid-functionalized carbon nanotubes. The supernatant layer may be utilized in forming films, coatings, articles and other materials, while the precipitate layer may be collected and recycled into another process.

The benefits of these particular methods of forming compositions that comprise conductive nanomaterials, such as functionalized carbon nanotubes, semiconductor nanowires, semiconductor nanoparticles, metal nanowires, or a combination thereof and at least one rheology additive may include a) acceptable and controllable changes, typically decreases, in the effective conductivity of the nanomaterials while maintaining sufficient light transmissiveness, b) the ability to obtain nanomaterials, such as carbon nanotubes, in stable water dispersions with relatively high concentration, with controllable Newtownian, psuedoplastic, or thixotropic viscosity responses and c) the ability to reduce or eliminate surfactants from the nanomaterial-containing dispersions used, which in turn means that those surfactants will not need to be removed before application to a surface or layer

### Photoimageable or Photosensitive Material

Along with the conductive component and the at least one rheology control additive, transparent conductive materials contemplated herein may further comprise at least one photoimageable or photosensitive material. The at least one photoimageable or photosensitive material may be added as a separate and independent component of the transparent conductive material or may be specifically grafted or coupled to the conductive component to form the transparent conductive material.

These photoimageable or photosensitive materials may comprise photoacid generators (PAG), photobase generators (PBG), free radical generators, polymeric or monomeric-based photoimageable materials, such as those described in POT Application Serial No.: PCT/CN2006/001351 entitled “Photosensitive Materials and Uses Thereof” and filed on Jun. 30, 2006, which is commonly-owned by Honeywell International Inc. and incorporated herein in its entirety by reference.

In addition, these conductive components may comprise grafted or extended segments that are designed to link and/or crosslink the conductive components and/or acid-functionalized carbon nanotubes into lines, layers or webs. For example, acrylic resins can be grafted onto the carbon nanotubes and nanowires in order to link and crosslink the conductive components. In addition, these resins may have the added benefit of adding the required photoimageable or photosensitive material to the conductive components.

The compositions and coatings contemplated herein may also comprise additional components such as at least one polymerization inhibitor, at least one light stabilizer, at least one adhesion promoter, at least one antifoam agent, at least one detergent, at least one flame retardant, at least one pigment, at least one plasticizer, at least one surfactant or a combination thereof. These materials are utilized in varying amounts in accordance with the particular use or application desired. When included, their amounts will be sufficient to provide increased storage stability yet still obtain adequate desirable properties for the composition. In some embodiments, contemplated compositions and coatings may further comprise phosphorus and/or boron doping. In those embodiments that comprise phosphorus and/or boron, these components are present in an amount of less than about 10% by weight of the composition. In other embodiments, these components are present in an amount ranging from about 10 parts per million to 10% by weight of the composition. Suitable inhibitors include benzoquinone, naphthaquinone, hydroquinone derivatives and mixtures thereof, Suitable light stablizers include hydroxybenzophenones; benzotriazoles; cyanoacrylates; triazines; oxanilide derivatives; poly(ethylene naphthalate); hindered amines; formamidines; cinnamates; malonate derivatives and combinations thereof.

Methods of forming patterned transparent conductive coatings include: a) providing and applying a layer comprising at least one photosensitive or photoimageable composition to a surface; b) providing and applying a layer comprising conductive nanomaterials, such as functionalized or unfunctionalized carbon nanotubes, semiconductor nanowires, semiconductor nanoparticles, metal nanowires, or a combination thereof and at least one rheology-control additive to the previously applied layer, and c) exposing and developing the layered material. In other embodiments, the layer comprising conductive nanomaterials, such as functionalized or unfunctionalized carbon nanotubes, semiconductor nanowires, semiconductor nanoparticles, metal nanowires, or a combination thereof and at least one rheology-control additive may be applied first, followed by the layer comprising at least one photosensitive or photoimageable composition, before the layered material is exposed and developed. In yet other embodiments, the transparent conductive composition may be prepared before application to the surface or substrate, wherein the material comprises conductive nanomaterials, such as functionalized or unfunctionalized carbon nanotubes, semiconductor nanowires, semiconductor nanoparticles, metal nanowires, or a combination thereof and at least one rheology-control additive and at least one photoimageable or photosensitive material. These novel methods correct many of the previously described problems of the prior art.

Electronic and optoelectronic devices are also contemplated herein, comprising the compositions, layers and films disclosed. The devices that can use the conductive films can include area electrodes for electrical and electrochemical devices, electromagnetic interference (EMI) and radio frequency interference (RFI) shields, ground planes for electronic devices, antistatic packaging, hole and injection layers for OLEDs and photovoltaic cells. The devices that can use the transparent conductive films include touchpanel electrodes, transparent EMI/RFI shields, transparent static dissipation films and packaging, electroluminescent lamp electrodes, Liquid crystal switching electrodes found on both the transistor side and the “common” or color filter side of the Liquid crystal cell, Plasma display front glass electrodes, and transparent resistive heaters.

Contemplated compositions are applied to suitable surfaces, such as layers, films or substrates depending on the projected end-use of the film formed from the composition. The solutions may also be laid down in a continuous film, which is patterned later, or a film that is selectively patterned. As contemplated herein, applying the solutions to a substrate to form a thin layer comprises any suitable method, such as spin-coating, slit-coating, cast-coating, Meyer rod coated, dip coating, brushing, rolling, spraying, and/or ink-jet printing. Prior to application of the compositions or coatings disclosed herein, the surface or substrate can be prepared for coating by standard and suitable cleaning methods. The solution is then applied and processed to achieve the desired type and consistency of coating. Although the general method is outlined above, it should be understood that these steps can be tailored for the selected transparent conductive material and the desired final product.

The term “substrate”, as used herein, includes any suitable surface where the compounds and/or compositions described herein are applied and/or formed. For example, a substrate may be a silicon wafer suitable tor producing an integrated circuit, and contemplated materials are applied onto the substrate by conventional methods. In another example, the substrate may comprise not only a silicon wafer but other layers that are designed to lie under the contemplated photosensitive compositions.

Suitable substrates include films, glass, ceramic, plastic, metal, paper, PTFE filter membranes, composite materials, silicon and compositions containing silicon such as crystalline silicon, polysilicon, amorphous silicon, epitaxial silicon, silicon dioxide (“SiO₂”), silicon nitride, silicon oxide, silicon oxycarbide, silicon carbide, silicon oxynitride, organosiloxanes, organosilicon glass, fluorinated silicon glass, indium tin oxide (ITO) glass, ITO coated plastic, and semiconductor materials such as gallium arsenide (“GaAs”), and mixtures thereof. In other embodiments, suitable substrates comprise at least one material common in the packaging and circuit board industries such as silicon, glass and polymers. A circuit board made of the compositions described herein may comprise surface patterns for various electrical conductor circuits. The circuit board may also include various reinforcements, such as woven non-conducting fibers or glass cloth. Contemplated circuit boards may also be single sided or double sided. In some embodiments, contemplated substrates include transparent glass, metal films for touchpanel electrodes, transparent-coated polymeric sheets used for electrostatic dissipation and electrostatic discharge protection, and electrodes for electroluminescent light sources.

The surface or substrate may comprise an optional pattern of raised lines, such as oxide, nitride, oxynitride, or metal lines which are formed by well known lithographic techniques. Suitable materials for the lines include silicon oxide, silicon nitride, silicon oxynitride, ITO, aluminium, copper, silver, chromium, tantalum, titanium, cobalt, nickel, gold, tungsten, or the combination thereof. Other optional features of the surface of a suitable substrate include an oxide layer, such as an oxide layer formed by heating a silicon wafer in air, or more preferably, an SiO₂ oxide layer formed by chemical vapor deposition of such art-recognized materials as, e.g., plasma-enhanced tetraethoxysilane oxide (“PETEOS”), plasma enhanced silane oxide (“PE silane”) and combinations thereof, as well as one or more previously formed silica dielectric films.

Once the transparent conductive material is utilized to form a layer or an article, it can be overcoated with at least one low refractive index material for light extraction. Suitable low refractive index materials include DuPont TEFLON AF™, Honeywell's ACCUOPTO-T™ and NANOGLASS™, acrylic coatings and sealers along with other suitable materials.

In some embodiments, surfaces contemplated herein may comprise any desirable substantially solid material, such as a glass, stainless steel or plastic substrate found in the optoelectronic manufacturing industry. Contemplated surfaces may be coated or uncoated, patterned or unpatterned, and may reside anywhere in the electronic or optoelectronic device. Some contemplated surfaces comprise a non-planar surface topography and other contemplated surfaces that have already been planarized. Particularly desirable surfaces comprise films, glass, ceramic, plastic, metal or coated metal, or composite material. Surfaces comprise at least one layer and in some instances comprise a plurality of layers. In other embodiments, the surface comprises a material common in the optoelectronic industries. Suitable surfaces contemplated herein may also include another previously formed layered stack, other layered component, or other component altogether.

### EXAMPLES

### Example 1

### Functionalization of Carbon Nanotubes

### Materials:

Purified Single Wall Carbon Nanotubes (SWNTs)
SWNTs purchased from Carbon Nanotechnology Inc. Houston Tex., P-grade, produced from a high pressure carbon monoxide method.
or
SWNTs, purchased from Chengdu Organic Chemical Company, Chengdu China, 90% SWNT grade, produced via CVD.
Sulfuric Acid, supplied by EMAD Chemicals.
Guaranteed Reagent. ACS Grade, 95.0-98.0%.
Nitric Acid, Solution, ARISTAR*. ACS Grade, 68.0-70.0%
Supplied by VWR International

### Procedure:

Into a 150 ml round bottom flask, 500 mg SWNTs were first added. A 40 ml mixture of 1:1 concentrated nitric acid and sulfuric acid were added to ensure all carbon nanotubes (CNTs) were washed down to the bottom of the flask. The flask was then connected to a reflux condenser. The mixture was heated to boiling and kept boiling and refluxed for 5-10 minutes. Subsequently, the mixture was diluted with about 50 ml of deionized water and allowed to cool in place for 15-20 minutes. The cooled mixture was filtered through a PTFE filter membrane (2 μm pore size), and the acid treated CN residue was repeatedly washed with deionized water for 3-5 times (150 ml in total). The acid treated CNT residue together with the filter paper was dried in air at 70° C. for few hours. The dried acid treated CNT residue was then separated from the filter paper by peeling the acid treated CNT residue away as a sheet or as a powder. This acid treated CNT residue will hereafter be referred to a “functionalized CNT”.

Approximately 325 mg of functionalized CNTs were collected. These functionalized CNTs were dispersible in water and certain organic solvents, including methanol, ethanol, iso-propanol, DMF, etc.

### Example 2

### Dispersion of Functionalized CNTs

### Material:

Isopropanol (IPA) or 2-Propanol, ACS Grade, 99.5%. Supplied by VWR International
Functionalized CNTs from Example 1

### Procedure:

2A: 100 mg functionalized CNTs (prepared in example 1) were added to a 5 dram vial together with 10 g deionized water. The mixture was then sonicated in a bath sonicator for 2 hrs, and a stable CNT dispersion in water was obtained.

2B: 15 mg of functionalized CNTs (prepared in example 1) were added to a 5 dram vial together with 10 g of a 3:1 mixture of isopropanol and deionized water. The mixture was then sonicated in a bath sonicator for 2 hrs, and a stable CNT dispersion in 3:1 isopropanol-water was obtained.

### Example 3

### Viscous Carbamate Liquid Preparation

### Viscous Carbamate Liquid Preparation in Water

### Materials:

Sec-butylamine, or 2-Aminobutane was purchased from TCI America.
Industrial grade carbon dioxide, CO₂, purchased from Air Products.

Procedure: Into a 500 ml flask, About 270 grams sec-butylamine and 30 grams de-ionized water were combined. Magnetic stirring was applied. CO₂ was bubbled into the bottom of the mixture with the flow speed of 300 sccm. After eight hours, the mixture viscosity increased to approximately 1200 cP. CO₂ bubbling was stopped. Thus, the sec-butylamine derived viscous carbamate liquid was prepared using H₂O and was ready to use.

### Viscous Carbamate Liquid Preparation in the Mixture of 3:1 IPA and Water

### Materials:

Sec-butylamine, or 2-Aminobutane was purchased from TCI America.
Industrial grade carbon dioxide(CO₂), purchased from Air Products.
Isopropanol (IPA) or 2-propanol, ACS Grade, 99.5%. Supplied by VWR International.

### Procedure:

Into a 500 ml flask, a 300 g mixture of sec-butylamine, IPA and deionized water was prepared at the ratio of 9:3:1. Magnetic stirring was also applied. CO₂ was bubbled into the bottom of the mixture with the flow speed around 300 sccm. After eight hours, the mixture viscosity increased to approximately 1100 CP. CO₂ bubbling was stopped. Thus, the sec-butylamine derived viscous carbamate liquid was prepared using IPA-H₂O and was ready to use.

### Example 4

### Rheology Adjustment of CNT Dispersion by Addition of Viscous Carbamate Liquid

4A: The functionalized CNTs of Example 1 were dispersed in a 3:1 mixture of IPA-H2O, at a weight concentration of 0.15% (see example 2 for dispersion method). The viscosity of this dispersion was approximately 1 cP.

4B: 10 g of this 4A dispersion was added into a glass vial. 5 g of the viscous carbamate liquid prepared using IPA-H₂O (see example 3) was added. The mixture was roll-milled for 5 minutes on a commercial jar-mill apparatus (Norton Company). The mixture was tested and found to have viscosity around 50 cP.

### Example 5

### Use of Rheology Adjusted Nanomaterial Formulation to Prepare a Transparent Conductive Material

The mixture prepared in example 4 was drawn down on a PET plastic film to form a coating, using a commercially available draw down rod (industry Tech, standard laboratory drawdown rod, size 10). After drying at 80 C for 10 minutes, a transparent electrical conductive film was formed with total transmittance of 86.1% and surface conductivity of 1*10⁸ ohm/square area.

Thus, specific embodiments and applications of rheology-controlled conductive materials and compositions, methods of production and their uses thereof have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A composition, comprising:
at least one conductive nanomaterial, and
at least one rheology control additive.

2. The composition of claim 1, wherein the at least one conductive nanomaterial comprises functionalized carbon nanotubes, unfunctionalized carbon nanotubes, semiconductor nanowires, semiconductor nanoparticles, metal nanowires, or a combination thereof.

3. The composition of claim 2, wherein the at least one conductive nanomaterial comprises a plurality of acid-functionalized carbon nanotubes.

4. The composition of claim 2, wherein the at least one conductive nanomaterial comprises a plurality of silver nanowires.

5. The composition of claim 1, comprising at least two different conductive nanomaterials.

6. The composition of claim 5, wherein the at least two different conductive nanomaterials comprise carbon nanotubes and silver nanowires.

7. The composition of claim 6, wherein the carbon nanotubes comprise acid-functionalized carbon nanotubes.

8. The composition of claim 1, wherein the at least one rheology control additive comprises at least one amine-acid adduct.

9. The composition of claim 8, wherein the at least one amine-acid adduct comprises carbamate chemistry.

10. The composition of claim 1, further comprising at least one solvent.

11. The composition of claim 10, wherein the at least one solvent comprises water.

12. The composition of claim 11, wherein the at least one solvent further comprises isopropyl alcohol.

13. The composition of claim 1, further comprising at least one photosensitive component.

14. The composition of claim 1, wherein the composition comprises no measurable amount of surfactant.

15. A film formed from the composition of claim 1.

16. The film of claim 15, wherein the film comprises an electrical sheet resistance of less than about 1E12 Ohm/square.

17. The film of claim 15, wherein the film has a percent light transmittance of at least 50%.

18. The film of claim 17, wherein the film has a percent light transmittance of at least 70%.

19. The film of claim 18, wherein the film has a percent light transmittance of at least 90%.

20. The film of claim 19, wherein the film is a transparent conductor.

21. An optoelectronic or electronic device comprising the film of claim 20.

22. The film of claim 15, wherein the film is patterned.

23. A conductive element comprising the film of claim 15.

24. A conductive element comprising the patterned film of claim 22.

25. A method of forming a conductive composition, comprising:
providing at least one conductive nanomaterial,
providing at least one rheology control additive, and
blending the at least one conductive nanomaterial and the at least one rheology control additive together to form the conductive composition.

26. The method of claim 25, further comprising:
providing at least one solvent, and
blending the at least one solvent with the at least one conductive nanomaterial and the at least one rheology control additive to form the conductive composition.

27. The method of claim 26, wherein the at least one solvent comprises water, isopropyl alcohol or a combination thereof.

28. The method of claim 25, wherein the at least one rheology control additive comprises an amine-acid adduct.

29. A method of forming a patterned transparent conductive coating, comprising:
providing and applying a layer comprising at least one photosensitive or photoimageable composition to a surface,
providing and applying a layer comprising at least one conductive nanomaterial and at least one rheology control additive,
exposing and developing the layered material, and
treating the layer comprising the at least one rheology control additive in order to remove at least part of the rheology control additive.

30. The method of claim 29, wherein the layer comprising at least one conductive nanomaterial and at least one rheology control additive is applied to the surface before the layer comprising at least one photosensitive or photoimageable composition.

31. The method of claim 30, wherein the at least one photosensitive or photoimageable composition, the at least one conductive nanomaterial and the at least one rheology control additive are in a single coating material.
